(19) United States
(12) Patent Application Publication
(10) Pub. No.: US 2017/0162909 A1
(43) Pub. Date: Jun. 8, 2017

(54) NONAQUEOUS ELECTROLYTIC SOLUTION INCLUDING ESTER HAVING 3,3,3-TRIFLUOROPROPIONATE GROUP AND NONAQUEOUS ELECTROLYTE BATTERY USING SAME

(71) Applicant: KANTO DENKA KOGYO CO., LTD., Tokyo (JP)

(72) Inventors: Osamu OMAE, Okayama (JP); Toshiaki OKAMOTO, Okayama (JP)

(21) Appl. No.: 15/324,044

(22) PCT Filed: May 12, 2015
(86) PCT No.: PCT/JP2015/063578

§ 371 Date: Jan. 5, 2017

(30) Foreign Application Priority Data
Jul. 8, 2014 (JP) 2014-140460

(51) Int. Cl. H01M 10/0569; H01M 10/0525

(52) U.S. Cl. CPC H01M 10/0569; H01M 10/0525; H01M 2300/004

(57) ABSTRACT

Provided are, a nonaqueous electrolytic solution for secondary batteries that has excellent oxidation resistance, prevents reaction between itself and electrodes, is resistant to decomposition under high-voltage conditions, and is capable of reducing the capacity decrease of and gas evolution in a secondary battery; and a nonaqueous electrolyte secondary battery using the nonaqueous electrolytic solution. The nonaqueous electrolytic solution for secondary batteries comprises a nonaqueous solvent comprising an ester having 3,3,3-trifluoropropionate groups represented by the following formula 1:

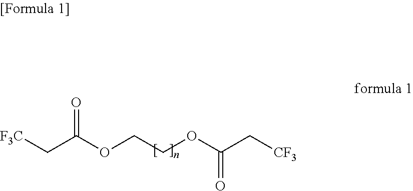

(wherein n represents an integer of 1 to 20.)
a fluorinated cyclic carbonate that is 4-fluoroethylene carbonate (FEC) or a derivative thereof, and at least one selected from a cyclic carbonate, a chain carbonate, and a fluorinated chain carboxylic acid ester; and
a lithium salt as an electrolyte.

### TECHNICAL FIELD

The present invention relates to a novel nonaqueous electrolytic solution and a nonaqueous electrolyte secondary battery including the nonaqueous electrolytic solution. The present invention, particularly relates to a nonaqueous electrolytic solution and a nonaqueous electrolyte secondary battery using the nonaqueous electrolytic solution, the nonaqueous electrolytic solution including: an ester having 3,3,3-trifluoropropionate groups at both terminals thereof and represented by general formula 1 given below; a fluorinated cyclic carbonate that is 4-fluoroethylene carbonate (FEC) or a derivative thereof; and at least one selected from a cyclic carbonate, a chain carbonate, and a fluorinated chain carboxylic acid ester.

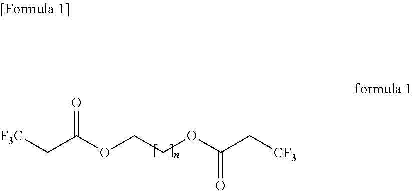

(wherein n represents an integer of 1 to 20.)

Nonaqueous electrolyte secondary batteries such as lithium secondary batteries, which case conventionally been used as power sources for so-called portable electronic devices such as mobile phones and laptop computers, are being required to have higher performance and higher energy density as the portable electronic devices improve performance and a range of applications of the nonaqueous electrolyte secondary batteries extends to, for example, in-vehicle driving power sources for automobiles etc.

In general, an electrolytic solution used in such a nonaqueous electrolyte secondary battery is mainly composed of an electrolyte and a nonaqueous solvent. A mixed solvent of a cyclic carbonate such as ethylene carbonate and a chain carbonate such as diethyl carbonate, ethyl methyl carbonate, or dimethyl carbonate is used as a main component of the nonaqueous solvent, and a solution of a lithium salt such as LiPF₆ or LiBF₄ dissolved in this mixed solvent is used.

To meet the demand for increasing the energy density of nonaqueous electrolyte secondary batteries, attempts to increase battery voltage have been made, for examples, a method in which the positive electrode potential is set high during charging to raise the charging voltage. In this method, however, a nonaqueous electrolytic solution as described above undergoes onidaiion-reduction reaction with a positive electrode or negative electrode due to increased reactivity of the electrode, thus causing deterioration in cycle characteristics or deterioration in battery characteristics during storage in charged state. To prevent such a reaction between a nonaqueous electrolytic solution and an electrode, Patent Literatures 1 and 2 listed below propose: using as the nonaqueous solvent of a nonaqueous electrolytic solution various kinds of fluoridated cyclic carbonate such as 4-fluoroethylene carbonate having good oxidation resistance and capable of undergoing reductive decomposition at a negative electrode to form a polymer coating that protects the negative electrode; or adding such a fluoridated cyclic carbonate to a nonaqueous eleotrolytic solution.

### CITATION LIST

### Patent Literature

Patent Literature 1: Japanese Patent Laid-Open No. 2007-504628

Patent Literature 2: Japanese Patent Laid-Open No. 2008-108689

However, a polymer coating formed by a fluorinated cyclic carbonate such as 4-fluoroethylene carbonate has lower stability than that formed by vinylene carbonate which is commonly known as a polymer coating formation additive for negative electrodes. This causes problems such as: decrease in battery capacity attributed to reformation reaction of the polymer coating that has once been dissolved or decomposed; and gas evolution during long-term storage or high-temperature storage. Vinylene carbonate mentioned above is superior as a polymer coating formation additive indeed, but has poor oxidation resistance leading to the problem of oxidative decomposition reaction at a positive electrode. There is therefore a demand for a compound having both good oxidation resistance and a function as a polymer coating formation additive that contributes to improvement in the characteristics of lithium secondary batteries.

### SUMMARY OF INVENTION

### Technical Problem

The present invention has been made to solve the above problems and has as its object to provide: a nonaqueous electrolytic solution for secondary batteries that has good oxidation resistance, that prevents reaction between itself and electrodes, and that reduces capacity decrease under use conditions such as high-voltage conditions where conventional nonaqueous electrolytic solutions undergo significant decomposition; and a nonaqueous electrolyte secondary battery using the nonaqueous electrolytic solution.

### Solution to Problem

As a result of a diligent study aimed at achieving the above object, the present inventors have found that a novel ester having an alkyl chain having 3,3,3-trifluoropropionate groups at both terminals thereof has a function as a polymer coating formation additive for lithium secondary batteries, and that the above object can be achieved by incorporating this ester in an electrolytic solution containing: a fluorinated cyclic carbonate that is 4-fluoroethylene carbonate (EEC) or a derivative thereof; and at least one selected from a cyclic carbonate, a chain carbonate, and a fluorinated chain carboxylic acid ester. The inventors have completed the present invention on the basis of these findings. Aspects of the present invention are as follows.

[1] A nonaqueous electrolytic solution for secondary batteries, comprising a nonaqueous solvent comprising an ester having 3,3,3-trifluoropropionate groups at both terminals thereof represented by the following formula 1:

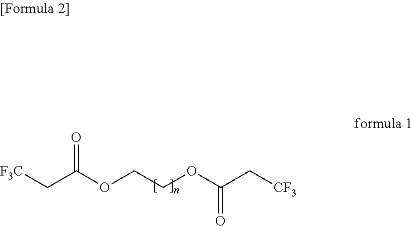

(wherein n represents an integer of 1 to 20.)
a fluorinated cyclic carbonate that is 4-fluoroethylene carbonate (FEC) or a derivative thereof, and at least one selected from a cyclic carbonate, a chain carbonate, and a fluorinated chain carboxylic acid ester; and a lithium salt as an electrolyte.

[2] The nonaqueous electrolytic solution for secondary batteries according to [1], wherein the ester having 3,3,3-trifluoropropionate groups at both terminals thereof is at least one selected from ethylenebis(3,3,3-trifluoropropionate) represented by the following formula 2

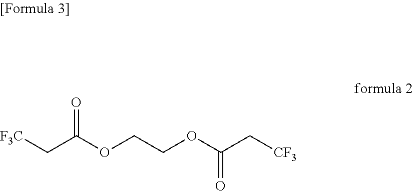 [SMILES: O=C(CC(F)(F)F)OCCOC(=O)CC(F)(F)F]

tetramethylenebis(3,3,3-trifluoropropionate) represented by the following formula 3:

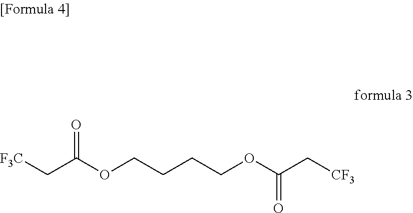 [SMILES: O=C(CC(F)(F)F)OCCCCOC(=O)CC(F)(F)F]

and a mixture thereof.

[3] The nonaqueous electrolytic solution for secondary batteries according to [1], wherein the ester having 3,3,3-trifluoropropionate groups at both terminals thereof is contained in an amount of 0.01 to 5 vol % relative to the total amount of the nonaqueous solvent.

[4] The nonaqueous electrolytic solution for secondary batteries according to [1], wherein the fluorinated cyclic carbonate that is 4fluoroethylene carbonate (FEC) or a derivative thereof is contained in an amount of 0.1 to 30 vol % relative to the total amount of the nonaqueous solvent.

[5] The nonaqueous electrolytic solution for secondary batteries according to [1], wherein the fluorinated chain carboxcylic acid ester is at least one selected from methyl 3,3,3-trifluoropropionate represented by CF₃CH₂COOCH₃, 2,2,2-trifluoroethyl acetate represented by CH₃COOCH₂CF₃, and a mixture thereof.

[6] A nonaqueous electrolyte secondary battery comprising: a negative electrode capable of absorbing and releasing lithium; a positive electrode capable of absorbing and releasing lithium; and the nonaqueous electrolytic solution for secondary batteries according to any one of [1] to [5].

### Advantageous Effects of Invention

The nonaqueous electrolytic solution for secondary batteries according to the present invention has excellent oxidation resistance, prevents reaction between itself and electrodes, is resistant to decomposition under high-voltage conditions, and is capable of reducing the capacity decrease of and gas evolution in a secondary battery.

### BRIEF DESCRIPTION OF DRAWINGS

FIG. 1 is a schematic diagram, of a three-electrode test cell according to an embodiment of the present invention.

FIG. 2 is a graph showing the result of cyclic voltammetry (thereinafter abbreviated as “CV”) measurement on a three-electrode test cell of Comparative Example 1 fabricated using a nonaqueous solvent not containing ethylenebis(3,3,3-trifluoropropionate).

FIG. 3 is a graph showing the result of CV measurement on a three-electrode test cell of Example 1 fabricated using a nonaqueous solvent containing ethylenebis (3,3,3-trifluoropropionate).

FIG. 4 is a graph showing the result of CV measurement on a three-electrode test cell of Example 2 fabricated using a nonaqueous solvent containing tetramethylenebis(3,3,3-trifluoropropionate).

FIG. 5 is a schematic diagram of a 2032 coin cell according to an embodiment of the present invention.

### DESCRIPTION OF EMBODIMENTS

The present invention provides a nonaqueous electrolytic solution for secondary batteries and a nonaqueous electrolyte secondary battery including the nonaqueous electrolytic solution, the nonaqueous electrolytic solution containing a lithium salt as an electrolyte in a nonaqueous solvent including: an ester having 3,3,3-trifluoropropionate groups at both terminals thereof and represented by formula 1 given below; a fluorinated cyclic carbonate that is 4-fluoroethylene carbonate (FEC) or a derivative thereof; and at least one selected from a cyclic carbonate, a chain carbonate, and a fluorinated chain carboxylic acid ester.

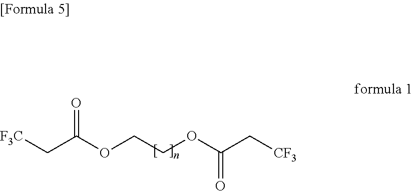

(wherein n represents an integer of 1 to 20.)

The ester having 3,3,3-trifluoropropionate groups at both terminals thereof and represented by formula 1 has an alkyl chain having at both terminals thereof 3,3,3-trifluoropropionate groups which can undergo deprotonation at the α position to form a fluorinated acrylic acid ester structure, and she ester is capable of forming on a negative electrode of a lithium, secondary battery a polymer coating having an effect of improving the battery characteristics of the lithium secondary battery. The ester further has good oxidation resistance.

The polymer coating is formed at the first charge of a nonaqueous electrolyte secondary battery including a positive elect rode capable of absorbing and releasing lithium, a negative electrode capable of absorbing and releasing lithium, a separator, and a nonaqueous electrolytic solution when the nonaqueous electrolytic solution used is the nonaqueous electrolytic solution according to the present invention which contains a lithium salt as an electrolyte in a nonaqueous solvent including the ester having 3,3,3-trifluoropropionate groups at both terminals thereof.

The polymer coating formed on the negative electrode can prevent reaction between the nonaqueous electrolytic solution and the negative electrode and thus provide good battery characteristics. If an appropriate polymer coating is not formed, decomposition reaction of the nonaqueous electrolytic solution will occur on the negative electrode, thus deteriorating the battery characteristics. Depending on the type of the nonaqueous solvent, intercalation and desorption of lithium into and from the negative electrode may fail to occur.

If the amount of the ester having 3,3,3-trifluoropropionate groups at both terminals thereof in the nonaqueous solvent is small, a satisfactory coating will not be formed on the negative electrode. If the amount of the ester is too large, excessive coating formation or electric conductivity decrease due to viscosity increase of the nonaqueous electrolytic solution will occur, deteriorating the battery characteristics. Thus, the amount of the ester having 3,3,3-trifluoropropionate groups at both terminals thereof is preferably in the range of 0.01 vol % to 5 vol % and particularly preferably in the range of 0.05 vol % to 3 vol % relative to the total, amount of the nonaqueous solvent.

The ester that has 3,3,3-trifluoropropionate groups at both terminal thereof and that can be preferably used in the present invention is at least one selected from ethylenebis(3,3,3-trifluoropropionate) represented by formula 2 given below, tetramethylenebis(3,3,3-trifluoropropionate) represented by formula 3 given below, and a mixture thereof. It is more preferable to use ethylenebis(3,3,3-trifluoropropionate) represented by formula 2 given below since ethylenebis(3,3,3-trifluoropropionate) does not cause excessive coating formation or a significant increase in the viscosity of the nonaqueous electrolytic solution.

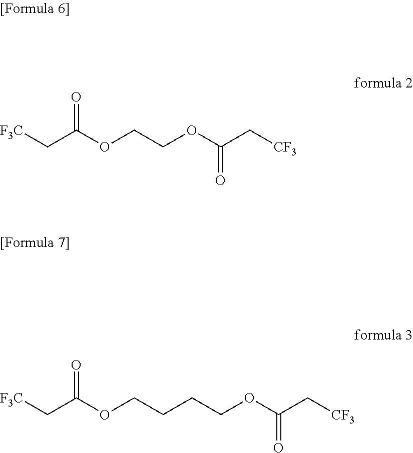 [SMILES: O=C(CC(F)(F)F)OCCOC(=O)CC(F)(F)F ; O=C(CC(F)(F)F)OCCCCOC(=O)CC(F)(F)F]

The ester having 3,3,3-trifluoropropionate groups at both terminals thereof can form a more stable polymer coating on the negative electrode of a lithium secondary battery than conventional esters such as methyl 3,3,3-trifluoropropionate which have a 3,3,3-trifluoropropionate group only at one terminal thereof, thus improving the cycle characteristics, in particular the capacity retention rate, of the nonaqueous electrolyte secondary battery.

In the nonaqueous electrolytic solution according to the present, invention, the above nonaqueous solvent can further include a high-dielectric solvent and a low-viscosity solvent. Preferred examples of the high-dielectric solvent include ethylene carbonate, propylene carbonate, and 4-fluoroethylene carbonate. Preferred examples of the low-viscosity solvent include dimethyl carbonate, ethyl, methyl carbonate, diethyl carbonate, ethyl acetate, methyl propionate, 2,2,2-trifluoroethyl acetate, and methyl 3,3,3-trifluoropropionate. It is preferable for the nonaqueous solvent to include any of 4-fluoroethylene carbonate, 2,2,2-trifluoroethyl acetate, and methyl 3,3,3-trifluoropropionate which are fluorinated solvents, particularly in terms of enhancing the oxidation resistance of the nonaqueous electrolytic solution under high-voltage conditions.

4-Fluoroethylene carbonate mentioned above, which is a fluorinated solvent, can undergo reductive decomposition at a negative electrode to form a polymer coating on the negative electrode, 4-Fluoroethylene carbonate can be used as a polymer coating formation additive in an amount, of, for example, 0.05 volt to 3 vol % relative to the total amount of the nonaqueous solvent. A composite polymer coating formed by a combination of the ester having 3,3,3-trifluoropropionate groups at both terminals thereof and represented by formula 1, and 4-fluoroethylene carbonate prevents further reductive decomposition of 4-fluoroethylene carbonate, and thus can provide an improvement in cycle characteristics and a reducing effect on gas evolution.

If the nonaqueous solvent further includes 4-fluoroethylene carbonate which is a fluorinated solvent but the amount of 4-fluoroethylene carbonate is small, the formation of a polymer coating from 4-fluoroethylene carbonate on the negative electrode will be unsatisfactory, and the battery characteristics will deteriorate due to reductive decomposition of another component of the nonaqueous solvent or to excessive coating formation. If the amount of 4-fluoroethylene carbonate is too large, the nonaqueous electrolytic solution will have an increased viscosity, leading to deterioration in load characteristics. Thus, the amount of 4-fluoroethylene carbonate is preferably in the range of 0.05 vol % to 40 vol % and more preferably in the range of 0.1 vol % to 30 vol % relative to the total amount of the nonaqueous solvent.

When the potential of the positive electrode is set to 4.36 V or more on a metal lithium basis, it is preferable to use 4-fluoroethylene carbonate as the high-dielectric solvent and a fluorinated carboxylic acid ester as the low-viscosity solvent, in terms of enhancing the oxidation resistance of the nonaqueous electrolytic solution under high-voltage conditions.

Examples of such a fluorinated carboxylic acid ester that can be preferably used in the nonaqueous electolytic solution according to the present invention include methyl 3,3,3-trifluoropropionate represented by CF₃CH₂COOCH₃ and 2,2,2-trifluoroethyl acetate represented by CH₃COOCH₂CF₃.

Examples of the electrolyte that cars be used in the nonaqueous electrolytic solution according to the present invention and that is a lithium salt soluble in the above nonaqueous solvent include LiPF₆, LiPO₂F₂, LiBF₄, LiClO₄, LiN(CF₃SO₂)₂, LiN(FSO₂)₂, LiCF₃SO₃, LiC(CF₃SO₂)₃, LiC(FSO₂)₃, LiCF₃CO₂, LiB(CF₃SO₃)₄, LiB(FSO₃)₄, Lib(C₂O₄)₃, and LiBF₂(C₂O₄). It is particularly preferable to use at least one lithium salt selected from LiPF₆, LiPO₂F₂, and LiBF₄, since the use of these lithium salts improves the electrical characteristics.

The positive electrode active material used in the positive electrode of the nonaqueous electrolyte secondary battery according to the present invention is not particularly limited. The positive electrode active material may be any material capable of absorbing and releasing lithium and having a noble potential, and any known positive electrode active materials commonly used can be employed. Examples include metal compounds such as metal oxides, metal hydroxides, metal sulfides, metal halides, and metal phosphates. Lithium-transition metal composite oxides having a layered structure as observed in intercalation compounds, a spinel structure, or an olivine structure can also be used. Preferred examples of the transition metal element include nickel, cobalt, manganese, titanium, and iron. It is also possible to use a transition metal composite oxide derived by introducing lithium, magnesium, aluminum, or titanium in addition to or in place of any of the above-mentioned transition metal elements. It is preferable to use a lithium-transition metal composite oxide having a layered structure, in particular to obtain a nonaqueous electrolyte secondary battery having high energy density. Specific examples include lithium-cobalt composite oxide, lithium-cobalt-nickel-manganese composite oxide, and lithium-cobalt-nickel-aluminum composite oxide.

The negative electrode active material used in the negative electrode of the nonaqueous electrolyte secondary battery according to the present invention is not particularly limited. The negative electrode active material may be any material capable of absorbing and releasing lithium, and any known negative electrode active materials commonly used can be employed. Examples of the materials that can be used include: metal lithium; lithium alloys such as lithium-silicon alloy and lithium-tin alloy; tin-silicon alloy; lithium-titanium alloy; tin-titanium alloy; titanium oxides; carbon materials; and electrically conductive polymers. Examples of the carbon materials include carbon materials such as (natural or artificial) graphite, (petroleum-derived or coal-derived) coke, fullerene, carbon nanotubes, carbon fibers, and burned organic matters. Examples of the tin compounds and titanium compounds that can be used include metal oxides such as SnO₂, SnO, and TiO₂ which have a lower potential than the positive electrode active material. It is particularly preferable to use a carbon material such as crystalline graphite that undergoes little volume change with absorption and release of lithium and is superior in terms of reversibility.

A separator (porous membrane) is interposed between the positive electrode and negative electrode to prevent short circuit. In this case, the nonaqueous electrolytic solution is used by being impregnated in the separator. The material and form of the porous membrane are not particularly limited, and may be any material and form that provide stability against the electrolytic solution and good solution retention. A porous sheet or non-woven fabric formed from a polyolefin such as polypropylene or polyethylene is preferred.

Examples of the material of the porous sheet include polyethylene, polypropylene, polyvinylidene fluoride, polyvinylidene chloride, polyacrylonitrile, polyacrylamide, polycarbonate, polyamide, polyimide, polytetrafluoroethylene, poly(meth)acrylic acid, and copolymers and mixtures thereof.

Aluminum or a steel material such as stainless steel, nickel steel, or copper steel can be used as the current collector of the positive electrode, and while copper, nickel, stainless steel, nickel-plated steel or the like can be used as the current collector of the negative electrode.

The shape of the nonaqueous electrolyte secondary battery according to the present invention which is constituted by the components described above is not particularly limited. The battery can have any of various shapes and can be a coin battery, cylindrical battery, rectangular battery, or pouch battery.

### EXAMPLES

Hereinafter, the present invention will be described in detail by way of examples. The present invention is not limited to these examples. In Production Examples, gas chromatography was performed using GC-2010 manufactured by Shimadzu Corporation (Column used: DB-1 or DB-5), and NMR spectroscopy was performed using Unity INOVA 500SW manufactured by Varian Medical Systems, Inc.

### Production Example 1

<Synthesis of ethylenebis(3,3,3-trifluoropropionate) Represented by Formula 2>

In a 50 mL reactor equipped with a fractionator, 6.10 g (98.3 mmol) of ethylene glycol and 28.2 g (220 mmol) of 3,3,3-trifluoropropionic acid were mixed. To this mixture was added 0.21 g (2.1 mmol) of 95% sulfuric acid, and the internal temperature of the reactor was increased to 100° C. under reduced, pressure (30 kPa) to allow a reaction to case place while water was distilled off. The reaction was allowed to proceed for 7 hours, followed by cooling so room temperature, then addition of 50 mL of water to the reaction product, and then stirring. An organic phase was separated and washed with 100 mL of a 5% aqueous sodium bicarbonate solution to obtain a crude product of ethylenebis(3,3,3-trifluoropropionate) in the form of a colorless, transparent liquid. The amount of the product was 24.3 g and the yield was 85%. As a result of gas chromatography, the gas chromatogram area attributed to ethylenebis(3,3,3-trifluoropropionate) was determined to be 97.2%. The crude product was purified by precision distillation under reduced pressure (5-ball Snyder column, 0.25 kPa, fraction at 80° C.) to give ethylenebis(3,3,3-trifluoropropionate) in the form of a colorless, transparent liquid. The gas chromatogram area attributed to the obtained fraction was 98.7%.

### [Spectrum Data]

Ethylenebis(3,3,3-trifluoropropionate)
¹H-NMR spectrum (500 MHz, CDCl₃) δ (ppm): 3.2 (4H, q, J=10 Hz), 4.42 (4H, s)
¹⁹F-NMR spectrum (470 MHz, CDCl₃) δ (ppm): −64.0 (6F, t, J=10 Hz)

### Production Example 2

<Synthesis of tetramethylenebis(3,3,3-trifluoropropionate) Represented by Formula 3>

In a 50 mL reactor equipped with a fractionator, 8.11 g (90.0 mmol) of 1,4-butanediol and 23.9 g (187 mmol) of 3,3,3-trifluoropropionic acid were mixed. To this mixture was added 0.16 g of (1.7 mmol) of 95% sulfuric acid, and the internal temperature of the reactor was increased to 120° C. under reduced pressure (40 kPa) to allow a reaction to take place while water was distilled off. The reaction was allowed to proceed for 8 hours, followed by cooling to room temperature, then addition of 50 mL of water to the reaction product, and then stirring. An organic phase was separated and washed with 100 mL of a 5% aqueous sodium bicarbonate solution to obtain a crude product of tetramethylenebis(3,3,3-trifluoropropionate) in the form of a light brown liquid. The amount of the product was 23.4 g and the yield was 84%. As a result of gas chromatography, the gas chromatogram area attributed to the tetramethylenebis(3,3,3-trifluoropropionate) was determined to be 97.3%. The crude product was purified by precision distillation under reduced pressure (5-ball Snyder column, 0.3 kPa, fraction at 116° C.) to give tetramethylenebis(3,3,3-trifluoropropionate) in the form of a colorless, transparent liquid. The gas chromatogram area attributed to the obtained fraction was 99.8%.

### [Spectrum Data]

Tetramethylenebis(3,3,3-trifluoropropionate)
¹H-NMR spectrum (500 MHz, CDCl₃) δ (ppm): 1.76 (4H, h, J=2.8 Hz), 3.19 (4H, q, J=10 Hz), 4.22 (4H, t, J=5.5 Hz)
¹⁹F-NMP spectrum (470 MHz, CDCl₃) δ (ppm): −63.9 (6F, t, J=10 Hz)

### Example 1

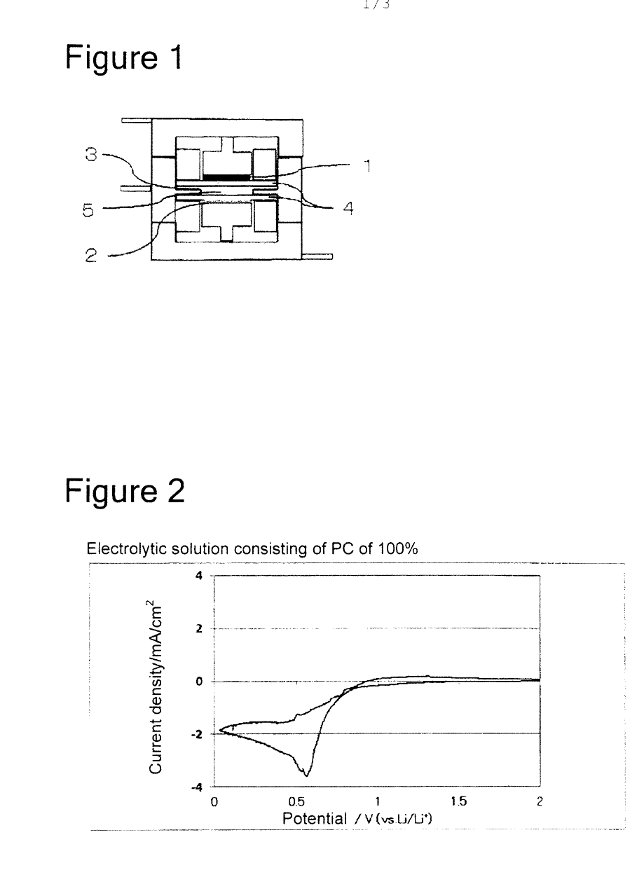

An amount of 3 wt % of ethylenebis(3,3,3-trifluoropropionate) produced in Production Example 1 and represented by formula 2 was mixed with 97 wt % of propylene carbonate (PC) to prepare a nonaqueous solvent. Lithium hexafluorophosphate (LiPF₆) as an electrolyte was dissolved in this nonaqueous solvent at a concentration of 1 mol/L to prepare a nonaqueous electrolytic solution. A three-electrode test cell as shown in FIG. 1 was fabricated using this nonaqueous electrolytic solution.

In the three-electrode cell, a sealed three-electrode cell manufactured by KeihinRika Industry Co., Ltd. was used, a predetermined size of a cut piece of natural graphite-coated electrode sheet (negative electrode in a single layer) manufactured by Piotrek Co., Ltd. was used as a working electrode 1, and metal lithium was used as a counter electrode 2 and as a reference electrode 3. These electrodes were immersed in a nonaqueous electolytic solution 5, with separators 4 being interposed between the electrodes.

### Example 2

An amount of 3 wt % of tetramethylenebis(3,3,3-trifluoropropionate) produced in Production Example 2 and represented by formula 3 was mixed with 97 wt % of propylene carbonate (PC) to prepare a nonaqueous solvent. Lithium hezafluorophosphate (LiPF₆) as an electrolyte was dissolved in this nonaqueous solvent at a concentration of 1 mol/L to prepare a nonaqueous electrolytic solution. A three-electrode test cell as shown in FIG. 1 was fabricated using this nonaqueous electrolytic solution.

### Comparative Example 1

A three-electrode test cell as shown in FIG. 1 was fabricated in the same manner as in Examples 1 and 2, except for using 100 wt % of propylene carbonate as the nonaqueous solvent.

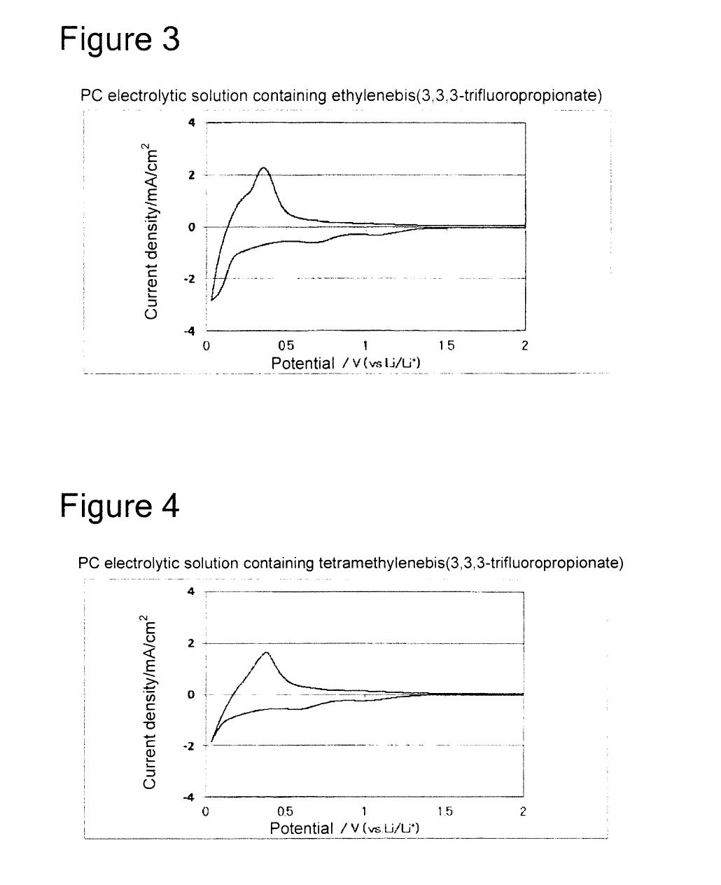

Each of the above three-electrode test cells was subjected to CV measurement in which the potential was scanned from the initial potential to 0 V and then to 2 V at a scan rate of 0.5 mV/sec. The result of CV measurement on the three-electrode test cell using the nonaqueous electrolytic solution of Comparative Example 1 is shown in FIG. 2, while the results of CV measurement on the three-electrode test cells using the nonaqueous electrolytic solutions of Examples 1 and 2 are shown in FIGS. 3 and 4, respectively.

FIG. 2 shows, for the case of using the nonaqueous electrolytic solution of Comparative Example 1 containing only propylene carbonate as the nonaqueous solvent, that a reduction current peak attributed to decomposition of propylene carbonate was observed at around 0.6 to 0.5 V and that any peak attributed to intercalation or desorption of lithium was not observed. This leads to the inference that no polymer coating was formed on the negative electrode serving as a working electrode.

FIG. 3 and FIG. 4 show, for the case of using the nonaqueous electrolytic solutions of Examples 1 and 2 containing the ester represented by formula 1, that a negative reduction current peak attributed to intercalation of lithium was observed at around 0 V, and that a positive oxidation current peak attributed to desorption of lithium was observed at around 0.4 V. This leads to the inference that a polymer coating was formed on the negative electrode serving as a working electrode by the ester represented by formula 1. Compounds capable of forming a polymer coating on a negative electrode are known to be useful as a coating formation additive for lithium-ion secondary batteries. The ester represented by formula 1 can thus be considered useful as a coating formation additive for lithium-ion secondary batteries.

### <Evaluation Test of Nonaqueous Electrolyte Secondary Batteries>

Next, nonaqueous electrolytic solutions containing ethylenebis(3,3,3-trifluoropropionate) (formula 2) of Production Example 1, which was confirmed by the results in Examples 1 and 2 to have the ability to form a polymer coating on negative electrodes, were used to fabricate nonaqueous electrolyte secondary batteries, and the batteries were subjected to an evaluation test to examine the effect provided by the addition of ethylenebis(3,3,3-trifluoropropionate).

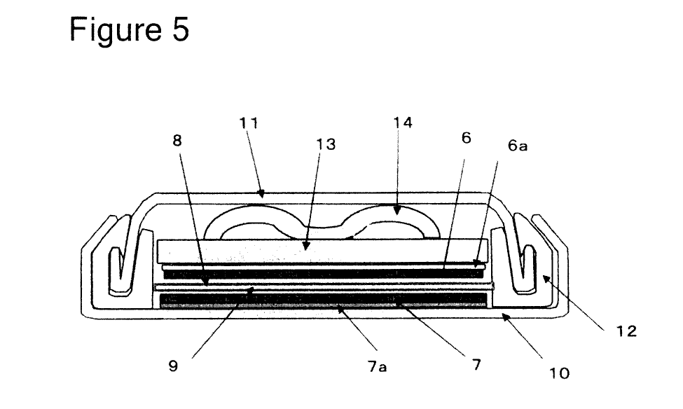

In the evaluation test, electrolytic solutions containing ethylenebis(3,3,3-trifluoropropionate) (formula 2) were used to fabricate nonaqueous electrolyte secondary batteries in the shape of a 2032 coin cell as shown in FIG. 5.

### <Fabrication Steps>

### [Fabrication of LiCoO₂ Positive Electrode]

An amount of 93 wt % of LiCoO₂ as a positive electrode active material, 4 wt % of acetylene black as a conductive material, and 3 wt % of polyvinylidene fluoride (PVDF) as a binder were mixed to give a positive electrode material. This positive electrode material was dispersed in N-methyl-2-pyrrolidone (NMP) to give a slurry. This slurry was applied and dried on one surface of a positive electrode current collector made of aluminum. This was followed by press forming to fabricate a LiCoO₂ positive electrode.

[Fabrication of LiNi_{1/3}Mn_{1/3}Mn_{1/3}Co_{1/3}O₂ Positive Electrode]

An amount of 92 wt % of LiNi_{1/3}Mn_{1/3}Co_{1/3}O₂ as a positive electrode material, and 3 wt % of polyvinylidene fluoride (PVDF) as a binder were mixed to give a positive electrode material. This positive electrode material was dispersed in N-methyl-2-pyrrolidone (NMP) to give a slurry. This slurry was applied and dried on one surface of a positive electrode current collector made of aluminum. This was followed by press forming to fabricate a LiNi_{1/3}Mn_{1/3}Mn_{1/3}Co_{1/3}O₂ positive electrode.

### [Fabrication of Graphite Negative Electrode]

An amount of 97 wt % of artificial graphite as a negative electrode active material, 2 wt % of styrene-butadiene rubber (SBR) as a binder, and 1 wt % of carboxymethyl cellulose (CMC) were mixed to give a negative electrode material. This negative electrode material was dispersed in water to give a slurry. This slurry was applied and dried on a negative electrode current collector made of copper. This was followed by press forming to fabricate a graphite negative electrode.

### [Assembly of Battery]

In each 2032 coin cell, a 2032 coin cell member made of SUS 316L was used, a predetermined size of a cut piece of the LiCoO₂ positive electrode or LiNi_{1/3}Mn_{1/3}Co_{1/3}O₂ positive electrode was used as a positive electrode 6, and a predetermined size of a cut piece of the graphite negative electrode was used as a negative electrode 7. A 25-μm-thick polypropylene separator 9 impregnated with a nonaqueous electrolytic solution 8 containing ethylenebis(3,3,3-trifluoropropionate) of Production Example 1 represented by formula 2 was inserted between the electrodes. In a case 10 fitted with a gasket 12 there was placed the assembly of the electrodes and separator, on which a spacer 13 and a web washer 14 were stacked. The nonaqueous electrolyte secondary battery in the shape of a 2032 coin cell was thus fabricated.

### Example 3

A mixed solvent of ethylene carbonate (EC) and ethyl methyl carbonate (EMC) at a volume ratio EC:EMC of 3:7 (this mixed solvent will hereinafter be abbreviated as “EC-EMC”) was used as a nonaqueous solvent. This mixed solvent (EC-EMC), 4-fluoroethylene carbonate (FEC) as a coating formation additive, and ethylenebis(3,3,3-trifluoropropionate) (EBFP, formula 2) of Production Example 1 were mixed at a volume ratio EC-EMC:FEC:EBFP of 99:0.5:0.5 to prepare a nonaqueous solvent. Lithium hexafluorophosphate (LiPF₆) as an electrolyte was dissolved in this nonaqueous solvent at a concentration of 1.1 mol/L to prepare a nonaqueous electrolytic solution. A nonaqueous electrolyte secondary battery in the shape of a 2032 coin cell as shown in FIG. 5 was fabricated using this nonaqueous electrolytic solution and the LiCoO₂ positive electrode.

### Example 4

A nonaqueous electrolyte secondary battery was fabricated in the same manner as in Example 3, except that a mixed solvent of ethylene carbonate (EC) and ethyl methyl carbonate (EMC) at a volume ratio EC:EMC of 3:7 (EC-EMC), 4-fluoroethylene carbonate (FEC) as a coating formation additive, and ethylenebis(3,3,3-trifluoropropionate) (EBFP, formula 2) of Production Example 1 were mixed at a volume ratio EC-EMC: FEC:EBFP of 99:0.9:0.1 and the resulting mixed solvent was used.

### Comparative Example 2

A mixed solvent of ethylene carbonate (EC) and ethyl methyl carbonate (EMC) at a volume ratio EC:EMC of 3:7 (EC-EMC) was used as a nonaqueous solvent, and lithium hexafluorophosphate (LiPF₆) as an electrolyte was dissolved in this nonaqueous solvent at a concentration of 1.1 mol/L to prepare a nonaqueous electrolytic solution. A nonaqueous electrolyte secondary battery in the shape of (2032 coin cell as shown in FIG. 5 was fabricated using this nonaqueous electrolytic solution and the LiCoO₂ positive electrode.

### Reference Example 3

A mixed solvent of ethylene carbonate (EC) and ethyl methyl carbonate (EMC) at a volume ration EC:EMC of 3:7 (EC-EMC) was used as a nonaqueous solvent. This mixed solvent and ethylenebis(3,3,3-trifluoropropionate (EBFP, formula 2) of Production Example 1 were mixed at a volume ratio EC-EMC: EBFP of 99:1 to prepare a nonaqueous solvent, and lithium hexafluorophosphate (LiPF₆) as an electrolyte was dissolved in this nonaqueous solvent at a concentration of 1.1 mol/L to prepare a nonaqueous electrolytic solution. A nonaqueous electrolyte secondary battery in the shape of a 2032 coin cell as shown in FIG. 5 was fabricated using this nonaqueous electrolytic solution and the LiCoO₂ positive electrode.

### Reference Example 4

A nonaqueous electrolyte secondary battery was fabricated in the same manner as in Reference Example 3, except that a mixed solvent of ethylene carbonate (EC) and ethyl methyl carbonate (EMC) at a volume ratio EC:EMC of 3:7 (EC-EMC) and ethylenebis(3,3,3-trifluoropropionate) EBFP, formula 2) of Production Example 1 were mixed at a volume ratio EC-EMC: EBFP of 99.9:0.1 and the resulting nonaqueous solvent was used.

### Comparative Example 5

A nonaqueous electrolyte secondary battery was fabricated in the same manner as in Reference Example 3, except that a mixed solvent of ethylene carbonate (EC) and ethyl methyl carbonate (EMC) at a volume ration EC:EMC of 3:7 (EC-EMC) and 4-fluoroethylene carbonate (FEC) were mixed at a volume ratio EC-EMC:FEC of 99:1 and the resulting nonaqueous solvent was used.

Each of the nonaqueous electrolyte secondary batteries of Examples 3 and 4, Reference Examples 3 and 4, and Comparative Examples 2 and 5, which were fabricated as described above, was charged to 4.35 V at a constant current of 3.5 mA at 25° C., and then charged at a constant voltage of 4.35 V until the current value reached 0.35 mA. After that, the battery was discharged to 2.75 V at a constant current of 3.5 mA, and the initial discharge capacity was measured. Subsequently, a 300-cycle charge-discharge test was conducted using the above charge -discharge conditions. For each nonaqueous electrolyte secondary battery, the ratios of the discharge capacity at the 100th cycle, that at the 200th cycle, and that at the 300th cycle to the initial discharge capacity defined as 100 were calculated as cycle capacity retention rates, which are shown in Table 1 below.

TABLE 1

| | | Composition of nonaqueous | | | Cycle capacity | | |
|---|---|---|---|---|---|---|---|
| | | solvent (vol %) | | | retention rate | | |
| | Electrolyte | Additive 1 | Additive 2 | Solvent | 100 | 200 | 300 |
| Example 3 | 1.1 mol/L | EBFP | FEC | EC-EMC | 97 | 92 | 86 |
| | LiPF₆ | 0.5 vol % | 0.5 vol % | (3:7 vol) | | | |
| Example 4 | | EBFP | FEC | 99.0 vol % | 98 | 93 | 88 |
| | | 0.1 vol % | 0.9 vol % | | | | |
| Comparative | 1.1 mol/L | — | — | EC-EMC | 95 | 89 | 74 |
| Example 2 | LiPF₆ | | | (3:7 vol) | | | |
| | | | | 100 vol % | | | |
| Reference | | EBFP | — | EC-EMC | 95 | 81 | — |
| Example 3 | | 1.0 vol % | | (3:7 vol) | | | |
| | | | | 99.0 vol % | | | |
| Reference | | EBFP | — | EC-EMC | 95 | 90 | 74 |
| Example 4 | | 0.1 vol % | | (3:7 vol) | | | |
| | | | | 99.9 vol % | | | |
| Comparative | | — | FEC | EC-EMC | 92 | 87 | 82 |
| Example 5 | | | 1.0 vol % | (3:7 vol) | | | |
| | | | | 99.0 vol % | | | |

The result of the 300-cycle charge-discharge test demonstrates that the nonaqueous electrolyte secondary batteries of Examples 3 and 4 including a nonaqueous solvent containing ethylenebis(3,3,3-trifluoropropionate) (EBFP, formula 2) and 4-fluoroethylene carbonate (FEC) showed higher cycle capacity retention rates and hence better cycle characteristics than the nonaqueous electrolyte secondary batteries of Comparative Examples 2 and 5.

The batteries of Reference Examples 3 and 4 including ethylenebis(3,3,3-trifluoropropionate) (EBFP, formula 2) alone showed no significant improvement in the cycle capacity retention rate, which indicates that ethylenebis(3,3,3-trifluoropropionate) can exert an improvement effect when used in combination with 4-fluoroethylene carbonate (FEC).

The batteries of Examples 3 and 4 showed higher cycle capacity retention rates also that the battery of Comparative Example 5 including 4-fluoroethylene carbonate (FEC) alone. This demonstrates that using ethylenebis(3,3,3-trifluoropropionate) (EBFP, formula 2) and 4-fluoroethylene carbonate (FEC) in combination improves the function of 4-fluoroethylene carbonate (FEC) as a polymer coating formation additive.

4-Fluoroethylene carbonate (FEC) described above, which is a fluorinated solvent, has a function as a polymer coating formation additive, has a high dielectric constant, and has good oxidation resistance, thus being beneficial as a nonaqueous solvent for high-voltage nonaqueous electrolyte secondary batteries. The results in Examples 3 to 4 demonstrate that ethylenebis(3,3,3-trifluoropropionate) (EBFP, formula 2) improved the function of 4-fluoroethylene carbonate (FEC) as a polymer coating formation additive, and is thus preferred as a polymer coating formation additive for high-voltage nonaqueous electrolyte secondary batteries including 4-fluoroethylene carbonated (FEC).

### <Evaluation Test of High-Voltage Nonaqueous Electrolyte Secondary Batteries>

High-Voltage nonaqueous electrolyte secondary batteries were fabricated using nonaqueous electrolytic solutions containing a nonaqueous solvent including: ethylenebis(3,3,3-trifluoropropionate) (EBFP, formula 2) or tertramethylenebis(3,3,3-trifluoropropionate) (TBFP, formula 3) which was confirmed by the results in Examples 3 ad 4 to have the effect of improving the function of 4-fluoroethhylene carbonate (FEC) as a polymer coating formation additive and improving the battery characteristics; and 4-fluoroethylene carbonate (FEC). The batteries were subjected to an evaluation test to examine the affect provided by the addition of ethylenebis(3,3,3-trifluoropropionate) or tetramethylenebis(3,3,3-trifluoropropionate).

### Example 5

A nonaqueous solvent was prepared by mixing 4-fluoroethylene carbonate (FEC), ethyl methyl carbonate (EMC), and ethylenebis(3,3,3-trifluoropropionate) (EBFP, formula 2) of Production Example 1 as a polymer coating formation additive at a volume ration FEC:EMC:EBFP of 20:79:1, and lithium hexafluorophosphat (LiPF₆) as an electrolyte was dissolved in his nonaqueous solvent at a concentration of 1 mol/L to prepare a nonaqueous electrolytic solution. A nonaqueous electrolyte secondary battery in the shape of a 2032 coin cell as shown in FIG. 5 was fabricated using this nonaqueous electrolytic solution and the LiCoO₂ positive electrode as a positive electrode.

### Example 6

A nonaqueous electrolyte secondary battery was fabricated in the same manner as in Example 5, except for using a nonaqueous solvent prepared by mixing 4-fluoroethylene carbonate (FEC), ethyl methyl carbonate (EMC), and ethylenebis(3,3,3-trifluoropropionate) (EBFP, formula 2) of Production Example 1 as a polymer coating formation additive at a volume ratio FEC:EMC:EBFP of 20.0:79.9:0.1.

### Example 7

A nonaqueous electrolyte secondary battery was fabricated in the same manner as in Example 5, except for using a nonaqueous solvent prepared by mixing 4-fluoroethylene carbonate (FEC), ethyl methyl carbonate (EMC), and tetramethylenebis(3,3,3-trifluoropropionate) (TBFP, formula 3) of Production Example 2 as a polymer coating formation additive at a volume ratio FEC:EMC:TBFP of 20:79:1.

### Example 8

A nonaqueous electrolyte secondary battery was fabricated in the same manner as in Example 5, except for using a nonaqueous solvent prepared by mixing 4-fluoroethylene carbonate (FEC), ethyl methyl carbonate (EMC), and tetramethylenebis(3,3,3-trifluoropropionate) (TBFP, formula 3) of Production Example 2 as a polymer coating formation additive at a volume ratio FEC:EMC:TBFP of 20.0:79.9: 0.1.

### Comparative Example 6

A nonaqueous electrolyte secondary battery was fabricated in the same manner as in Example 5, except for using a nonaqueous solvent prepared by mixing 4-fluoroethylene carbonate (FEC) and ethyl methyl carbonate (EMC) at a volume ratio FEC:EMC of 20:80.

### Comparative Example 7

A nonaqueous electrolyte secondary battery was fabricated in the same manner as in Example 5, except for using a nonaqueous solvent prepared by mixing 4-fluoroethylene carbonate (FEC), ethyl methyl carbonate (EMC), and vinylene carbonate (VC) as a polymer coating formation additive at a volume ratio FEC:EMC:VC of 20:79:1.

Each of the nonaqueous electrolyte secondary batteries of Examples 5 to 8 and Comparative Examples 6 and 7, which ware fabricated as described above, was charged to 4.5 V at a constant current of 3.5 mil at 25° C., and then charged at a constant voltage of 4.5 V until the current value reached 0.35 mA. After that, the battery was discharged to 2.75 V at a constant current, of 3.5 mA. The initial discharge capacity of each nonaqueous electrolyte secondary battery was thus measured. Subsequently, a 200-cycle charge-discharge test was conducted using the above charge-discharge conditions. For each nonaqueous electrolyte secondary battery, the ratios of the discharge capacity at the 50th cycle, that at the 100th cycle, and that at the 200th cycle to the initial discharge capacity defined, as 100 were calculated as cycle capacity retention rates, which are shown in Table 2 below.

TABLE 2

| | | Composition of nonaqueous | | | Cycle capacity | | |
|---|---|---|---|---|---|---|---|
| | | solvent (vol %) | | | retention rate | | |
| | Electrolyte | Additive 1 | Solvent 1 | Solvent 2 | 50 | 100 | 200 |
| Example 5 | 1.0 mol/L | EBFP | FEC 20.0 vol % | EMC 79.0 vol % | 89 | 87 | 79 |
| | LiPF₆ | 1.0 vol % | | | | | |
| Example 6 | | EBFP | FEC 20.0 vol % | EMC 79.9 vol % | 89 | 87 | 80 |
| | | 0.1 vol % | | | | | |
| Example 7 | | TBFP | FEC 20.0 vol % | EMC 79.0 vol % | 91 | 86 | 71 |
| | | 1.0 vol % | | | | | |
| Example 8 | | TBFP | FEC 20.0 vol % | EMC 79.9 vol % | 89 | 85 | 77 |
| | | 0.1 vol % | | | | | |
| Comparative | 1.0 mol/L | — | FEC 20.0 vol % | EMC 80.0 vol % | 91 | 86 | 66 |
| Example 6 | LiPF₆ | | | | | | |
| Comparative | | VC | FEC 20.0 vol % | EMC 79.0 vol % | 88 | 84 | 69 |
| Example 7 | | 1.0 vol % | | | | | |

Table 2 demonstrates that the nonaqueous electrolyte secondary batteries of Examples 5 to 8, which were fabricated using a nonaqueous solvent including as a polymer coating formation additive ethylenebis(3,3,3-trifluoropropionate; (EBFP, formula 2) or tetramethylenebis(3,3,3-trifluoropropionate) (TBFP, formula 3) which is the ester represented by formula 1 given above, showed higher capacity retention rates and hence better charge-discharge cycle characteristics at a high voltage of 4.5 V than the nonaqueous electrolyte secondary batteries of Comparative Examples 6 and 7, respectively.

The nonaqueous electrolyte secondary battery of Comparative Example 7 including vinylene carbonate (VC), which is known to have a function as a polymer coating formation additive, showed a low improving effect on the cycle capacity retention rate at a high voltage of 4.5 V, and this can be attributed to the poor oxidation resistance of vinylene carbonate (VC).

The ester represented by formula 1 given above has a function as a polymer coating formation additive for forming a polymer coating on negative electrodes, in particular, the addition of the ester represented by formula 1 given above, together with 4-fluoroethylene carbonate (FEC), to a nonaqueous electrolytic solution leads to modification of a polymer coating formed on a negative electrode by reductive decomposition of 4-fluoroethylene carbonate (FEC), thus resulting in an improvement in battery characteristics such as the cycle capacity retention rate.

Furthermore, the ester represented by formula 1 given above has better oxidation resistance than vinylene carbonate (VC). This is presumably why the addition of the ester, together with 4-fluoroethylene carbonate (FEC) which also has excellent oxidation resistance, to a nonaqueous electrolytic solution allows the provision of an electrolytic solution suitable for high-voltage nonaqueous electrolytic solution secondary batteries.

### <Evaluation Test of Reducing Effect on Gas Evolution>

Next, an evaluation test was conducted to examine the reducing effect on gas evolution that the ester represented by formula 1 provides by modifying a polymer coating formed by reductive decomposition of 4-fluoroethylene carbonate (FEC).

### Example 9

In this evaluation test, an aluminum-laminated nonaqueous electrolyte secondary battery was fabricated using a nonaqueous electrolytic solution containing 4-fluoroethylene carbonate (FEC), and the battery was charged. Next, the charged electrodes were removed, washed, and then dried. After that, each electrode was sealed again in an aluminum-laminated bag together with a nonaqueous solvent, and stored at 85° C. for 4 days to evaluate the amount of gas evolved.

In the aluminum-laminated battery, LiNi_{1/3}Mn_{1/3}Co_{1/3}O₂ was used for the positive electrode, while graphite was used for the negative electrode.

The LiNi_{1/3}Mn_{1/3}Co_{1/3}O₂ positive electrode was cut into a 50 mm×50 mm piece, to which an aluminum tab with a sealant was ultrasonically welded. The graphite negative electrode was cut into a 50 mm×50 mm piece, to which a nickel tab with a sealant was ultrasonically welded.

The electrolytic solution containing 4-fluoroethylene carbonate (FEC) was prepared as follows: A nonaqueous solvent was prepared by mixing 4-fluoroethylene carbonate (FEC) and ethyl methyl carbonate (EMC) at a volume ratio FEC:EMC of 2:8, and lithium hexafluorophosphate (LiPF₆) as an electrolyte was dissolved in this nonaqueous solvent at a concentration of 1 mol/L.

A separator made of polyethylene was interposed between the above positive electrode and negative electrode, and the electrodes were fixed with a tape to integrate the electrodes and separator into an electrode assembly. The electrode assembly was dried under vacuum at 85° C. for 1 hour. Next, the electrode assembly was placed into a tubular aluminum-laminated bag having both ends open. The aluminum tab ultrasonically welded to the positive electrode and the nickel tab ultrasonically welded to the negative electrode were led out through one opening, and this opening was sealed by welding. The electrolytic solution prepared was added dropwise into the aluminum-laminated bag through the other opening. The aluminum-laminated bag was degassed, and the other opening was sealed by welding to fabricate an aluminum-laminated battery.

The thus fabricated aluminum-laminated secondary battery was charged to 4.4 V at a constant current of 10 mA at 25° C., and then charged at a constant voltage of 4.4 V until the current value reached 1 mA. After that, the battery was discharged to 2.70 V at a constant current of 10 mA. Subsequently, the battery was charged again to 4.4 V at a constant current of 10 mA at 25° C., then charged at a constant voltage of 4.4 V and held at this voltage for 12 hours.

The positive electrode was removed from the battery having undergone the 12-hour constant voltage charging, and washed with 10 ml of dimethyl carbonate twice. The positive electrode vase then dried under reduced pressure to eliminate the dimethyl carbonate. The dried positive electrode was put in an aluminum-laminated bag having three sides sealed. An amount of 2.5 mL of a nonaqueous solvent prepared by mixing 4-fluoroethylene carbonate (FEC) with 3 wt % of ethylenebis(3,3,3-trifluoropropionate) (EBFP, formula 2) was added dropwise into the aluminum-laminated bag through its opening, and the opening was sealed.

The negative electrode was removed from the above battery, and washed with 10 ml of dimethyl carbonate twice. The negative electrode was then dried under reduced pressure to eliminate the dimethyl carbonate. The dried negative electrode was put in an aluminum-laminated bag having three sides sealed. An amount of 2.5 mL of a nonaqueous solvent prepared by mixing 4-fluoroethylene carbonate (FEC) with 3 wt % of ethylenebis(3,3,3-trifluoropropionate) (EBFP, formula 2) was added dropwise into the aluminum-laminated bag through its opening, and the opening was sealed.

Each aluminum-laminated bag packed with the nonaqueous solvent was stored at 85° C. for 4 days, after which the bag was sufficiently cooled and than immersed in a water bath to measure its volume. The amount of gas evolved was determined from the change in volume before and after the storage. The evaluation results are shown in Table 3.

### Comparative Example 3

The amount of gas evolved was determined in the same manner as in Example 9, except that the nonaqueous solvent added dropwise consisted only of 4-fluoroethylene carbonate (FEC). The evaluation results are shown in Table 3.

TABLE 3

| | | | | Amount of |
|---|---|---|---|---|
| | | Nonaqueous | Storage | gas evolved |
| | Electrode | solvent | conditions | (mL) |
| Example 9 | LiNi_{1/3}Mn_{1/3}Co_{1/3}O₂ | FEC + EBFP | At 85° C. | 0.25 |
| | Artificial | (3 wt %) | for 4 days | 0.32 |
| | graphite | | | |
| Comparative | LiNi_{1/3}Mn_{1/3}Co_{1/3}O₂ | FEC | At 85° C. | 0.24 |
| Example 8 | Artificial | | for 4 days | 0.60 |
| | graphite | | | |

Table 3 shows that the amount of gas evolved when the nonaqueous solvent containing 4-fluoroethylene carbonate (FEC) and ethylenebis(3,3,3-trifluoropropionate) (EBFP, formula 2) which is the ester represented by formula 1 given above was stored together with the charged artificial graphite negative electrode in Example 9 was nearly half of the amount of gas evolved when the nonaqueous solvent not containing ethylenebis(3,3,3-trifluoropropionate) (EBFP, formula 2) was stored together with the charged artificial graphite negative electrode in Comparative Example 8. This leads to the conclusion that the ester represented by formula 1 given above reduces the gas evolution by modifying a polymer coating formed by reductive decomposition of 4-fluoroethylene carbonate (FEC).

In addition, the amount of gas evolved when the nonaqueous solvent containing 4-fluoroethylene carbonate (FEC) and ethylenebis(3,3,3-trifluoropropionate) (EBFP, formula 2) was stored together with the charged LiNi_{1/3}Mn_{1/3}Co_{1/3}O₂ positive electrode in Example 9 was nearly equal to the amount of gas evolved when 4-fluoroethylene carbonate (FEC) was stored together with the charged LiNi_{1/3}Mn_{1/3}Co_{1/3}O₂ positive electrode in Comparative Example 8. This confirmed that ethylenebis(3,3,3-trifluoropropionate) does not promote gas evolution at the positive electrode.

### <Evaluation Test of Modification Effect on Polymer Coating>

Next, evaluation was made to prove that the ester represented by formula 1 given above exerts the effect of modifying a polymer coating also when used in a nonaqueous electrolytic solution containing 4-fluoroethylene carbonate (FEC) as a high-dielectric solvent and a fluorinated carboxylic acid ester as a low-viscosity solvent which are preferred in terms of enhancing the oxidation resistance of the nonaqueous electrolytic solution under high-voltage conditions.

### Example 10

A nonaqueous solvent was prepared by mixing 4-fluoroethylene carbonate (FEC), 2,2,2-trifluoroethyl acetate (FEA, CH₃COOCH₃CF₃), and ethylenebis(3,3,3-trifluoropropionate) (EBFP, formula 2) as a polymer coating formation additive at a volume ratio FEC:FEA:EBFP of 20:79:1, and lithium hexafluorophosphate (LiPF₈) as an electrolyte was dissolved in this nonaqueous solvent at a concentration of 1 mol/L to prepare a nonaqueous electrolytic solution. A nonaqueous electrolyte secondary battery in the shape of a 2032 coin cell as shown in FIG. 5 was fabricated using this nonaqueous electrolytic solution and the LiCoO₂ positive electrode as a positive electrode.

### Example 11

A nonaqueous electrolyte secondary battery was fabricated in the same manner as in Example 10, except for using a nonaqueous solvent prepared by mixing 4-fluoroethylene carbonate (FEC), methyl 3,3,3-trifluoropropionate (FMP, CF₃CH₂COOCH₃), and ethylenebis(3,3,3-trifluoropropionate) (EBFP, formula 2) as a polymer coating formation additive at a volume ratio FEC:FMP:EBFP of 20:9:1.

### Comparative Example 9

A nonaqueous electrolyte secondary battery was fabricated in the same manner as in Example 10, except for using a nonaqueous solvent prepared by mixing 4-fluoroethylene carbonate (FEC) and 2,2,2-trifluoroethyl acetate (FEA, CH₃COOCH₂CF₃) at a volume ratio FEC:FEA of 20:80 without adding ethylenebis (3,3,3-trifluoropropionate) (EBFP, formula 2).

### Comparative Example 10

A nonaqueous electrolyte secondary battery was fabricated in the same manner as in Example 10, except for using a nonaqueous solvent prepared by mixing 4-fluoroethylene carbonate (FEC) and methyl 3,3,3-trifluoropropionate (FMP, CF₃CH₂COOCH₃) at a volume ration FEC:FMP of 20:0 without adding ethylenebis(3,3,3-trifluoropropionate) (EBFP, formula 2).

Each of the fabricated nonaqueous electrolyte secondary batteries of Examples 10 and 11 and Comparative Examples 9 and 10 was charged to 4.35 V at a constant current of 3.5 mA at 25° C., and then charged at a constant voltage of 4.35 V until the current value reached 0.35 mA. After that, the battery was discharged to 2.75 V at a constant current of 3.5 mA. The initial discharge capacity of each nonaqueous elecrolyte secondary battery was thus measured. The initial discharge capacity of the nonaqueous electrolyte secondary battery of Comparative Example 9 was defined as 100, with respect to which the ratio of the initial discharge capacity of each of the other nonaqueous electrolyte secondary batteries was calculated. The results are shown in Table 4 below.

Next, each of the above nonaqueous electrolyte secondary batteries of Examples 10 and 11 and Comparative Examples 9 and 10 was charged to 4.35 V at a constant current of 3.5 mA at 25° C., and then charged at a constant voltage of 4.35 V until the current value reached 0.35 mA. After that, the battery was discharged to 2.75 V at a constant current of 3.5 mA to measure the pre-storage discharge capacity D₁.

Next, each of the above nonaqueous electrolyte secondary batteries was charged to 4.35 V at a constant voltage of 4.35 V until the current value reached 0.35 mA. Each nonaqueous electrolyte secondary battery thus charged was stored in a thermostatic chamber at 60° C. for 10 days.

The battery voltage of each nonaqueous electrolyte secondary battery was measured before and after the storage. The changes in voltage are shown in Table 4 below.

Furthermore, after the storage, each nonaqueous electrolyte secondary battery was discharged to 2.75 V at a constant current of 3.5 mA at 25° C. to measure the post-storage remaining capacity D₂.

Subsequently, each of the above nonaqueous electrolyte secondary batteries was charged to 4.35 V at a constant current of 3.5 mA at 25° C., and then charged at a constant voltage of 4.35 V until the current value reached 0.35 mA. After that, each nonaqueous electrolyte secondary battery was discharged to 2.75 V at a constant current of 3.5 mA to measure the post-storage recovered capacity D₃.

On the basis of the pre-storage discharge capacity D₁, post-storage remaining capacity D₂, and post-storage recovered capacity D₃ which were measured as described above, the post-storage capacity remaining rate (%) and capacity recovery rate (%) were determined by the formulae shown below for each of the nonaqueous electrolyte secondary batteries of Examples 10 and 11 and Comparative Examples 9 and 10. The results are shown in Table 4 below.

Capacity remaining rate (%)=(D₂/D₁)×100

Capacity recovery rate (%)=(D₁/D₁)×100

TABLE 4

| | | | | | | | Capacity | Capacity |
|---|---|---|---|---|---|---|---|---|
| | | Composition of nonaqueous solvent | | | Initial | Voltage | remaining | recovery |
| | | (vol %) | | | discharge | variation | rate | rate |
| | Electrolyte | Additive 1 | Solvent 1 | Solvent 2 | capacity | (mv) | (%) | (%) |
| Example 10 | 1.0 mol/L | EBFP | FEC | FEA | 101 | 182 | 71 | 81 |
| | LiPF₆ | 1.0 vol % | 20.0 vol % | 79.0 vol % | | | | |
| Example 11 | | EBFP | FEC | FMP | 100 | 170 | 72 | 80 |
| | | 1.0 vol % | 20.0 vol % | 79.0 vol % | | | | |
| Comparative | 1.0 mol/L | — | FEC | FEA | 100 | 209 | 63 | 77 |
| Example 9 | LiPF₆ | | 20.0 vol % | 80.0 vol % | | | | |
| Comparative | | — | FEC | FMP | 99 | 176 | 69 | 73 |
| Example 10 | | | 20.0 vol % | 80.0 vol % | | | | |

Table 4 demonstrates that the nonaqueous electrolyte secondary batteries of Examples 10 and 11 and Comparative Examples 9 and 10 yielded similar levels of initial discharge capacity, and that the nonaqueous electrolyte secondary batteries of Examples 10 and 11, which were fabricated using a nonaqueous solvent containing 4-fluoroethylene carbonate (FEC), 2,2,2-trifluoroethyl acetate (FEA, CH₃COOCH₂CF₃) or methyl 3,3,3-trifluoroethyl acetate (FEA, CH₃COOCH₂CF₃) which is a fluorinated chain carboxylic acid ester, and ethylenebis(3,3,3-trifluoropropionate) (EBFP, formula 2) which is the ester represented by formula 1 and serves as a polymer coating formation additive, showed a smaller voltage variation and higher capacity remaining rate and capacity recovery rate that the nonaqueous electrolyte secondary batteries of Comparative Examples 9 and 10 which did not include ethylenebis(3,3,3-trifluoropropionate) (EBFP, formula 2). A nonaqueous electrolytic solution using a nonaqueous solvent containing 4fluoroethylene carbonate (FEC) as a high-dielectric solvent, a fluorinated carboxylic acid ester as a low-viscosity solvent, and ethylenebis(3,3,3-trifluoropropionate) (EBFP, formula 2) which is the ester represented by formula 1 is concluded to be capable of modifying the polymer coating to be formed and thus providing good batter characteristics.

### REFERENCE SINGS LIST

1 Working electrode

2 Counter electrode

3 Reference electrode

4 Separator

5 Electrolytic solution

6 Positive electrode

6a Positive electrode current collector

7 Negative electrode

7a Negative electrode current collector

8 Nonaqueous electrolytic solution

9 Separator

10 Case

11 Cap

12 Gasket

13 Spacer

14 Web washer

1. A nonaqueous electrolytic solution for secondary batteries, comprising:
a nonaqueous solvent comprising
an ester having 3,3,3-trifluoropropionate groups represented by the following formula 1: 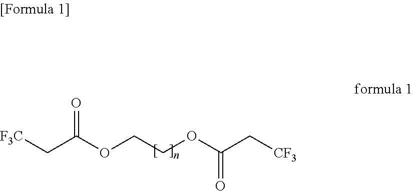
(wherein n represents an integer of 1 to 20.)
a fluorinated cyclic carbonate that is 4-fluoroethylene carbonate (FEC) or a derivative thereof, and
at least one selected from a cyclic carbonate, a chain carbonate, and a fluorinated chain carboxylic acid ester; and
a lithium salt as an electrolyte.

2. The nonaqueous electrolytic solution for secondary batteries according to claim 1, wherein the ester having 3,3,3-trifluoropropionate groups is at least one selected from ethylenebis(3,3,3-trifluoropropionate) represented by the following formula 2: 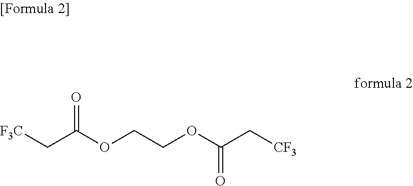 [SMILES: O=C(CC(F)(F)F)OCCOC(=O)CC(F)(F)F]
tetramethylenebis(3,3,3-trifluoropropionate) represented by the following formula 3: 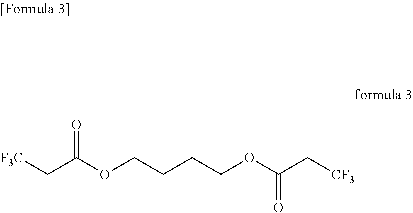 [SMILES: O=C(CC(F)(F)F)OCCCCOC(=O)CC(F)(F)F]
and a mixture thereof. cm 3. The nonaqueous electrolytic solution for secondary batteries according to claim 1, wherein the ester having 3,3,3-trifluoropropionate groups is contained in an amount of 0.01 to 5 vol % relative to the total amount of the nonaqueous solvent.

4. The nonaqueous electrolytic solution for secondary batteries according to claim 1, wherein the fluorinated cyclic carbonate that is 4-fluoroethylene carbonate (FEC) or a derivative thereof is contained in an amount of 0.1 to 30 vol % relative to the total amount of the nonaqueous solvent.

5. The nonaqueous electrolytic solution for secondary batteries according to claim 1, wherein the fluorinated chain carboxylic acid ester is at least one selected from methyl 3,3,3-trifluoropropionate represented by CF₃CH₂COOCH₃, 2,2,2-trifluoroethyl acetate represented by CH₃COOCH₂CF₃, and a mixture thereof.

6. A nonaqueous electrolyte secondary battery comprising:
a negative electrode capable of absorbing and releasing lithium;
a positive electrode capable of absorbing and releasing lithium; and
the nonaqueous electrolytic solution for secondary batteries according to claim 1.
